(19) United States
(12) Patent Application Publication
(10) Pub. No.: US 2014/0288061 A1
(43) Pub. Date: Sep. 25, 2014

(54) INSECTICIDE COMPOSITIONS AND PROCESS

(71) Applicant: BASF Corporation, Florham Park, NJ (US)

(72) Inventor: Steven R. Sims, Maryland Heights, MO (US)

(21) Appl. No.: 14/294,798

(22) Filed: Jun. 3, 2014

Related U.S. Application Data
(62) Division of application No. 13/078,641, filed on Apr. 1, 2011.
Application No. 13/078,641 is a continuation of application No. 10/939,747, filed on Sep. 13, 2004, now abandoned.

(51) Int. Cl. A01N 25/30; A01N 43/50; A01N 43/88; A01N 43/78

(52) U.S. Cl. CPC A01N 25/30; A01N 43/78; A01N 43/50; A01N 43/88
USPC 514/229.2; 514/365; 514/341

(57) ABSTRACT

A synergistic insecticide composition comprising:

a) an ethoxylated surfactant of the formula:

R—O—(CH₂—CH₂O)ₓ—H

wherein R is a linear alkyl group of from approximately 0 to 15 carbon atoms and X has an average value from about 1 to 3; and

b) an insecticide selected from the group consisting of nicotinoids, chlorfenapyr, pyrethrum and piperonyl butoxide. Such compositions are effective against a wide range of insects.

### CROSS-REFERENCE TO RELATED APPLICATION

This application is a divisional of U.S. patent application Ser. No. 13/078,641, filed Apr. 1, 2011, which is a continuation of U.S. patent application Ser. No. 10/939,747, filed Sep. 13, 2004, each of which are incorporated herein by reference in their entirety.

### BACKGROUND OF THE INVENTION

This invention relates to insecticide compositions and a process for controlling insect populations and, more particularly, to synergistic insecticide compositions containing linear exthoxylated alcohol surfactants and their use in controlling insect populations.

Insecticidal soaps are commonly used for the population suppression of soft-bodied plant pests such as aphids, mites, psyllids, scales and whiteflies (Olkowski, et al., 1991 Common Sense Pest Control, Taunton Press, 715 p.). Maximum effectiveness requires direct contact with the insect/mite and often repeated applications. Although larger insect species such as earwigs, cabbageworms, tent caterpillars, sawfly larvae, squash bugs and stink bugs appear on product labels (Olkowski, et al., supra; Concern®, Insect Killing Soap, Woodstream Corp.; M-Pede, Mycogen Corp.), little published information is available on the use of soaps to control other “harder” bodied insects such as cockroaches and crickets (Olkowski, et al., supra). Improved soap or new detergent formulations could desirably provide effective control of cockroaches and other pests of urban developments without the use of more toxic insecticidal ingredients. For example, Acarina such as spider mites (Osborne 1984, J. Econ Entomol 77:734-737) and ixodid ticks (Allan and Patrican, 1995, J. Med. Entomol. 32:16-20 and Patrican and Allen, 1995 J. Med. Entomol 32:859-863 and 1995, Med. Vet. Entomol. 9:293-299) can be controlled to some extent by appropriate applications of insecticidal soap. A recent study (Szumlas, 2002, J. Econ. Entomol. 95:390-398) demonstrated that the German cockroach Blattella germanica (L.) was susceptible to sprays of liquid dishwashing detergent sold under the trademark DAWN ULTRA (Proctor and Gamble Company, Cincinnati, Ohio). There is little additional published information on the insecticidal toxicity of other detergents and surfactants despite the fact that such compounds are extensively used as adjuvants in agricultural chemical formulations and often have substantial biological activity in addition to their function as wetting agents (Imai, et al. 1994, Appl. Entomol. Zool. 29:389-393; Liu and Stansly 2000, Pest Management Science 56:861-866; and Tipping, et al., 2003, J. Econ. Entomol 96:246-250). Additionally, existing information is often difficult to interpret because adjuvants and surfactants tested are usually formulated as mixtures rather than single compounds.

A previous analysis of linear alcohol ethoxylate structure and corresponding biological activity to aquatic invertebrates employed multiple regression techniques to relate fathead minnow (Pimephales promelas Rafinesque) and Daphnia magna Strauss LC50 values to carbon chain length and number of moles of ethoxylation (EO) (Wong, et al., 1997 Environ. Toxicol. Chem. 16:1970-1976). Their model predicted increasing toxicity with decreasing EO number and increasing alkyl chain length. The average alkyl chain length had a greater effect on toxicity than the average EO groups. Similarly, Maki and Bishop, (1979, Arch. Environ. Contam. Toxicol. 8:599-612) demonstrated that increasing EO values within a C14 linear alcohol ethoxylate alkyl chain series resulted in a linear decrease in Daphnia mortality. Dorn, et al. (1999, Environ. Tox. 14(3):293-300) found the most toxic compound to Daphnia magna was C14-15E07 and within a C9-11E06, C12-13E06.5 and C14-14E07 series there was a twofold increase in Daphnia mortality with each two carbon addition in alkyl chain length. The stream mesocosm studies of Gillespie, et al. (1996, Environ, Toxicol. Chem. 15:1418-1422; 1997, Aquat. Toxicol. 37:221-236; 1998, Ecotox Environ. Safety 41:215-221) also support the hypothesis of increasing toxicity on aquatic invertebrates, including insects, with increasing alkyl chain length of the linear alcohol ethoxylates. Not all studies demonstrate increasing toxicity with increasing alkyl chain length. Schott (1973, J. Pharm. Sci. 62:341-343) hypothesized that maximum toxicity should occur in intermediate members of a homologous series of anionic surfactants since “active” monomeric (non-micellar) molecules are limited by the critical micelle concentration and decreasing solubility as alkyl chain length increases. Baillie et al., (1989, Inter. J. Pharm. 53:241-248) provided data supporting this theory using a series of polyoxyethylene alkyl ethers and motility inhibition of the protozoan Tetrahymena elliotti.

There is a continuing need, therefore, to identify surfactants which may be useful as insecticides without having the drawbacks of highly toxic materials.

### SUMMARY OF THE INVENTION

Among the several objects of the invention may be noted the provision of certain linear ethoxylated alcohol surfactants which are effective for use in controlling insect populations; the provision of synergistic insecticide compositions containing such a surfactant together with an insecticide component from the group consisting of nicotinoids, chlorfenapyr, pyrethrum and piperonyl butoxide; the provision of such surfactants and synergistic insecticide compositions which are effective against a wide range of insects; and the provision of synergistic insecticide compositions and process which may be readily and economically practiced for controlling insect populations. Other objects and features will be in part apparent and in part pointed out hereinafter.

Briefly, the recent invention is directed to a synergistic insecticide composition comprising a) an ethoxylated surfactant of the formula:

R—O—(CH₂—CH₂O)ₓ—H

wherein R is a linear alkyl group of from approximately 9 to 15 carbon atoms and X has an average value of from about 1 to 3; and b) an insecticide selected from the group consisting of nicotinoids, chlorfenapyr, pyrethrum and piperonyl butoxide. The invention is also directed to a process for controlling insect populations by applying to an insect habitat an ethoxylated surfactant of the above-noted formula. The invention is further directed to a process for controlling insect populations by applying to an insect habitat a synergistic insecticide composition as defined above.

### BRIEF DESCRIPTION OF THE DRAWINGS

FIG. 1 is a graph showing the effect of increasing alkyl chain length, in a series of linear ethoxylated alcohols, on contact toxicity to adult male Blattella germanica; and

FIG. 2 is a graph showing the relationship between HLB numbers of linear ethoxylated alcohols (Tomadol series) and 24 hour mortality of adult male Blattella germanica exposed to a 2 μl dose of a 50% solution.

Regression equation: % dead=126.95−8.30 HLB, R²=0.85, p<0.0001.

### DESCRIPTION OF THE PREFERRED EMBODIMENTS

In accordance with the present invention, it has now been found that linear ethoxylated alcohol surfactants of the formula:

R—O—(CH₂—CH₂O)ₓ—H

wherein R is a linear alkyl group of from approximately 9 to 15 carbon atoms and X has an average value of from about 1 to 3 are effective per se for use in controlling insect populations. It has also been found that such a surfactant in combination with an insecticide from the group consisting of nicotinoids, chlorfenapyr, pyrethrum and piperonyl butoxide provides synergistic insecticide compositions which are effective in controlling insect populations. As will be seen from the test results set forth hereinafter, within groups of ethoxylated alcohol surfactants of equal carbon chain length, insecticidal activity, measured by LT50 and 24 hour post treatment mortality, was negatively correlated with the amount or degree of ethoxylation. There was a highly significant negative correlation between the ethoxylated alcohol surfactant HLB value and contact toxicity. The ethoxylated alcohol surfactant with the lowest HLB value, Tomadol 23-1 (HLB=3.7) produced the greatest 24 hour cockroach mortality.

As indicated in the examples set forth hereinafter, sixteen linear primary alcohol ethoxylates of the above-noted formula in the Tomadol series (Tomah Products, Inc., Milton, Wis.) were tested for their comparative toxicity to adult male German cockroaches. The various Tomadol linear alcohol ethoxylates are named based on the number of carbon atoms contained in the product. Thus, linear alcohol “91” is a blend of C9, C10 and C11 alcohols whereas the linear alcohol “1” is C11 alcohol. In the following Tomadol alcohol ethoxylates, the description of the parent alcohol “91” for example is followed by a number indicating the average number of moles of ethylene oxide added per mole of alcohol: Tomadol 91-2.5, 91-6, 91-8, 1-3, 1-5, 1-7,1-9, 23-1, 23-3, 23-5, 23-6.5, 25-3, 25-7, 25-12, 45-7 and 45-13. It will be understood that linear alcohol ethoxylates of the above-noted formula other than Tomadol ethoxylates may be used in the practice of the invention.

Each of the above-noted Tomadol linear alcohol ethoxylates is characterized by a unique hydrophile/lipophile (HLB) number. The HLB number represents the concept that the emulsifying efficiency of a surfactant is associated with the polarity of the molecule. HLB numbers less than 6 generally indicate utility as water in oil emulsifiers while HLB numbers of 8 or greater indicate application as oil in water emulsifiers or detergents. As shown by the data presented hereinafter, linear alcohol ethoxylate surfactants having an HLB of less than approximately 8.7 are preferred for use in the practice of the invention. HLB is a good predictor of biological activity within a C9 through C14-15 alkyl series of linear alcohol ethoxylates and the best predictor of the most toxic compound. The utility of HLB values as predictors of German cockroach toxicity is associated with the polarity and lipophilicity of the compound. The more oil-soluble surfactants have low HLB numbers whereas those with high HLB numbers tend to be more water soluble. Tomadol 91-2.5, 1-3, 23.1 and 23-3 have low water solubility. The HLB number for nonionic surfactants is directly proportional to the EO content of the compound. It is believed that the “oil-loving” nature of the most toxic linear alcohol ethoxylates may enhance their ability to bind to and penetrate the greasy-waxy cockroach epicuticle and enter the body to affect internal target sites.

In another embodiment of the present invention, it has been found that linear alcohol ethoxylates of the above-noted formula combined with commonly used insecticides significantly synergizes the insecticidal activity of the combination. Thus, as shown by the data presented hereinafter, the linear alcohol ethoxylate Tomadol 23-1 significantly synergized the insecticidal activity (reduced the LC50) of the insecticides chlorfenapyr, pyrethrum, piperonyl butoxide and the nicotinoids clothianidin, imadacloprid and thiamethoxam. Tomadol 23-1 did not synergize the activity of cyfluthrin, acephate or propoxur.

The linear alcohol ethoxylates of the above-noted formula and the synergistic insecticide compositions of the invention are effective against a wide range of insects. These include but are not limited to the following species: Ctenocephalides felis (Bouché) [Cat flea], Galleria mellonella L. [Greater wax moth], Harmonia axyridis Pallas [Multicolored Asian Ladybeetle]; Oncopeltus fasciatus (Dallas) (Large Milkweed Bug); Musca domestica L. (House fly); Periplaneta americana (L.) (American cockroach), Pollenia rudis (F.) [Cluster fly]; Lucilia sp., Oryzaephilus surinamensis (L.) (Sawtoothed grain beetle), Polistes exclamans (Viereck) (paper wasp); Polistes fuscatus (Fab.) (Golden paper wasp); Vespula maculifrons (du Buysson) (Eastern yellowjacket); Artogeia rapae (L.) (Imported cabbageworm); Diabrotica undecimpunctata howardi Barber (Southern corn rootworm); Apis mellifera L. (Honeybee); Melanoplus sp. (grasshopper); Phaenicia sericata (Meigen) (Green bottle fly); Camponotus pennsylvanicus De Geer (Black Carpenter ant); Drosophila melanogaster Meigen, Myzus persicae (Sulzer) (Green Peach Aphid), Tenebrio molitor L. (Yellow mealworm), Thermobia domestica (Packard) (firebrat) and Ostrinia nubilalis (Hübner) (European corn borer).

The following examples illustrate the practice of the invention:

### EXAMPLE 1

Dose-response evaluations were performed on 1-4 week old adults SJC Strain (S.C. Johnson & Son, Racine, Wis.) German cockroaches, Blattella germanica, L. Insects were individually transferred using a 7″ (18 cm) AESCULAP forceps to 100×20 mm polystyrene Petri dishes. The inside edge of the dishes was lightly coated with a layer of (1:3) mineral oil+petroleum jelly to minimize insect escape. Approximately 10 cockroaches were transferred to each dish and then anesthetized with a 15-25 second exposure to CO₂. Anesthetized cockroaches were positioned with their ventral side up in the bottom of the Petri dish. A 2 μl drop of test solution was applied to the area between the meso- and methathoracic legs using a Rainen L-10 10 μl pipette. Control cockroaches were treated with a 2 μl drop of the solvent, 100% ethyl alcohol.

Synergy tests used to calculate LC50 value were evaluated after 24 hours. Structure—activity tests used to calculate LT50 values were scored approximately every 30 minutes for the first two hours following treatment followed by approximate hourly readings to hour 8 with a final reading at 24 hours. Cockroaches were scored as either alive (dorsal side up, active movement when abdomen prodded) or moribund/dead (dorsal side up and no movement when abdomen prodded or ventral side up and insect unable to right itself).

The response of adult German cockroaches to the Tomadol series of ethoxylated alcohols is shown in Table 1:

TABLE 1
Contact toxicity of the Tomadol ™ series of linear
ethoxylated alcohols on adult German cockroaches.

| | | | | Number | Percentage |
|---|---|---|---|---|---|
| Ethoxylated | | | | insects | dead after 24 |
| alcohol | HLB | LT50 +/− CI (minutes) | | tested | hours (+/−1 SE) |
| 91-2.5 | 8.5 | 95.4 | (16.7-210.2)* | 121 | 44.4 (9.7) |
| 91-6 | 12.4 | | | 120 | 11.7 (2.2) |
| 91-8 | 13.9 | | | 120 | 10.8 (6.7) |
| 1-3 | 8.7 | 176.0 | (125.0-240.0) | 173 | 73.7 (6.2) |
| 1-5 | 11.2 | | | 140 | 27.2 (7.8) |
| 1-7 | 12.9 | | | 130 | 15.3 (6.3) |
| 1-9 | 13.9 | | | 130 | 4.7 (2.0) |
| 23-1 | 3.7 | 120.3 | (93.7-149.6) | 163 | 91.2 (3.3) |
| 23-3 | 7.9 | 327.4 | (262.0-416.1) | 163 | 70.3 (5.2) |
| 23-5 | 10.7 | | | 120 | 30.0 (3.0) |
| 23-6.5 | 12 | | | 120 | 19.2 (7.0) |
| 25-3 | 7.5 | 576.7 | (507.7-662.8) | 212 | 75.4 (5.1) |
| 25-7 | 12.3 | | | 80 | 21.7 (4.4) |
| 25-12 | 14.4 | | | 90 | 17.1 (5.3) |
| 45-7 | 11.6 | | | 120 | 30.8 (6.0) |
| 45-13 | 14.4 | | | 122 | 27.7 (3.6) |

*Number dead @ 24 hours less than 50% due to recovery

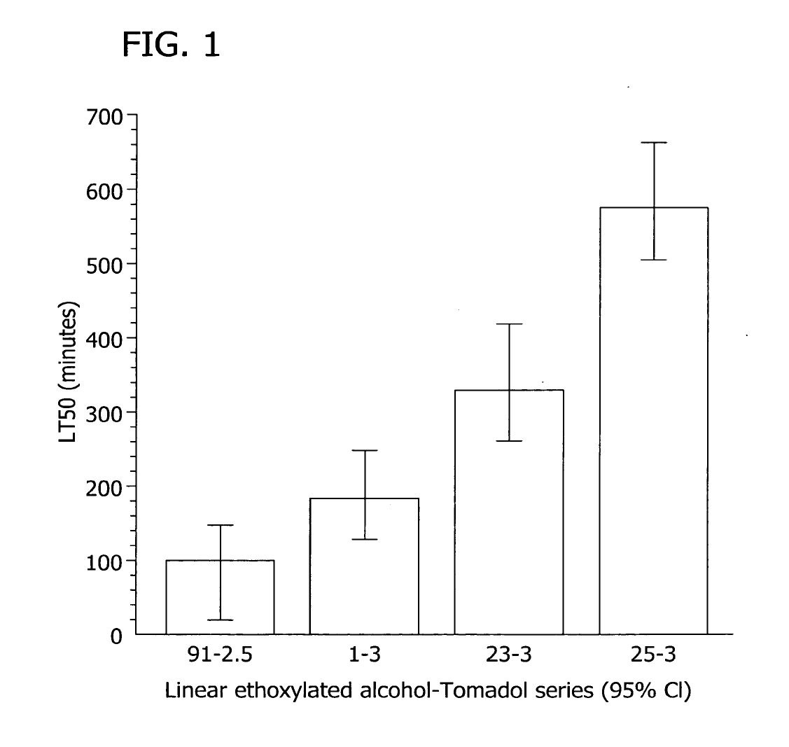

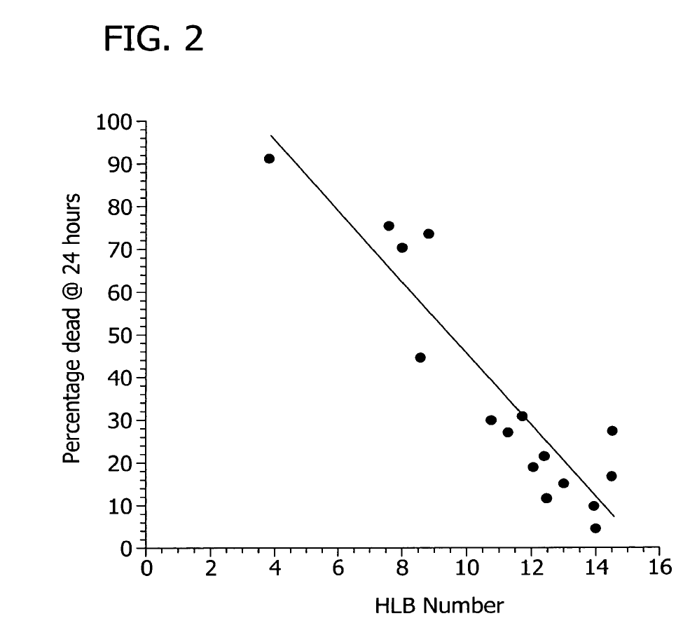

Five of the ethoxylated alcohols, generally those with the least amount of ethoxylation, were sufficiently toxic to permit calculation of an LT50 value. Tomadol 91-2.5 had the lowest LT50 but there was substantial recovery (>40%) of knocked down insects with this compound reducing the 24 hour mortality to 44.4%. Tomadol 23-1 was somewhat slower at knockdown (higher (LT50) but produced high mortality (91.2%) at 24 hours. The relationship between the LT50 and the HLB values of the five linear ethoxylated alcohols 91-2.5, 1-3, 23-1, 23-3 and 25-5 was not significant (F=0.099, p>0.7735). Within a series of compounds sharing the same or similar degrees of ethoxylation (3 moles), there was a negative correlation between carbon chain length and LT50 value (see FIG. 1). In this series, Tomadol 25-3 had the highest LT50 value and Tomadol 91-2.5 had the lowest. Within each series of compounds with the same carbon chain length, the 24 hour mortality was greatest in the compound with the least amount of ethoxylation. As ethoxylation increased, within a series, mortality decreased (see Table 1). The HLB value of the linear alcohol ethoxylates was highly predictive of the biological activity of all 16 compounds tested (see FIG. 2). The linear fit of the line with the equation: Percent dead=126.95 - 8.30 HLB explained 85% of the mortality variation among the alcohol ethoxylates studied (F=79.7, DF=15, P<0.0001).

### EXAMPLE 2

Example 1 was repeated in studying the effect of Tomadol 23-1 at 10% combined with commonly used insecticides and the results are presented in Tables 2 and 3.

TABLE 2
Response of German cockroaches to insecticides applied in combination
with a 10% solution (ETCH) of Tomadol 23-1. Dosage was 2 μl per insect.

| Compound | | | | Synergist | |
|---|---|---|---|---|---|
| (chemical class) | LC50 (%) [95% CI] | | Slope [95% CI] | Ratio | Significance |
| chlorfenapyr | 0.4062 | [0.2662-0.6679] | 1.1448 [0.8625-1.4270] | | |
| (pyrrole) | | | | | |
| chlorfenapyr + | 0.0513 | [0.0289-0.0875] | 0.8438 [0.6099-1.0776] | 7.9 | * |
| 10% Tomadol 23-1 | | | | | |
| clothianidin | 0.0020 | [0.0010-0.0038] | 1.6500 [0.6538-2.6462] | | |
| (nicotinoid) | | | | | |
| clothianidin + | 0.0003 | [0.0002-0.0005] | 1.2129 [0.8340-1.5919] | 6.7 | * |
| Tomadol 23-1 | | | | | |
| imidacloprid | 0.0219 | [0.0145-0.0337] | 3.1103 [1.9613-4.2594] | | |
| (nicotinoid) | | | | | |
| imidacloprid + | 0.0065 | [0.0042-0.0098] | 1.3353 [0.9198-1.7507] | 3.3 | * |
| 10% Tomadol 23-1 | | | | | |
| thiamethoxam | 0.0038 | [0.0027-0/0059] | 1.2698 [0.9121-1.6276] | | |
| (nicotinoid) | | | | | |
| thiamethoxam + | 0.0015 | [0.0010-0.0022] | 1.2097 [0.8031-1.6163] | 2.5 | * |
| 10% Tomadol 23-1 | | | | | |
| pyrethrum | 0.0068 | [0.0053-0.0086] | 1.7280 [1.3531-2.1031 | | |
| (pyrethrins | | | | | |
| pyrethrum + | 0.0028 | [0.0022-0.0036] | 1.8810 [1.4411-2.3209] | 2.4 | * |
| 10% Tomadol 23-1 | | | | | |
| cyfluthrin | 0.0050 | [0.0040-0.0065] | 2.6299 [2.3349-2.9249] | | |
| (pyrethroid) | | | | | |
| cyfluthrin + | 0.0066 | [0.0054-0.0081] | 2.8047 [2.2155-3.3950] | 0.8 | ns |
| 10% Tomadol 23-1 | | | | | |
| acephate | 0.0051 | [0.0027-0.0079] | 1.8600 [1.5560-2.164] | | |
| (organophosphate) | | | | | |
| acephate + | 0.0043 | [0.0035-0.0051 | 4.099 [3.4650-4.7330] | 1.2 | ns |
| 10% Tomadol 23-1 | | | | | |
| propoxur | 0.0101 | [0.0032-0.0141] | 3.6919 [0.8944-6.4894] | | |
| (carbamate) | | | | | |
| propoxur + | 0.0182 | [0.0157-0.0215] | 3.3561 [2.3306-4.3816] | 0.6 | |
| 10% Tomadol 23-1 | | | | | |

TABLE 3
Susceptibility of insect species to the
linear ethoxylated alcohol, Tomadol 23-1.

| | SAMPLE | PERCENT | |
|---|---|---|---|
| COMPOUND | SIZE | MORTALITY | SIGNIFICANCE |
| piperonyl butoxide | 170 | 6.4 | |
| (10%) | | | |
| Tomadol 23-1 | 170 | 19.7 | |
| (20%) | | | |
| piperonyl butoxide | 180 | 46.7 | F-14.94, |
| (10%) + Tomadol | | | p < 0.002 |
| 23-1 (20%) | | | |

As can be seen, Tomadol 23-1 significantly synergized the insecticidal activity of chlorfenapyr, pyrethrum, piperonyl butoxide and the nicotinoids clothianidin, imidacloprid and thiamethoxam. Piperonyl butoxide at 10% caused 6.4% mortality (mean of 6 replications) and Tomadol 23-1 at 20% produced 19.7% mortality (see Table 3). The combination of piperonyl butoxide and Tomadol 23-1 increased cockroach mortality to 46.7%. The mean difference between Tomadol 23-1 and Tomadol 23-1 plus piperonyl butoxide was highly significant (Tukey HSD, F=14.94, p<0.002).

As can be seen, all three nicotinoid insecticides examined were synergized in combination with a sublethal dose of Tomadol 23-1 suggesting that synergy may be a general response for nicotinyl compounds effecting the nicotinic acetylcholine receptor site in insects. Synergy was also demonstrated for chlorfenapyr, pyrethrum and piperonyl butoxide. The synthetic pyrethroid cyfluthrin was not synergized nor were representative members of the organophosphate and carbamate groups.

### EXAMPLE 3

Using the procedure set forth in Example 1, the biological activity of linear alcohol ethoxylates of the above-noted formula against a taxonomically wide range of insect species was studied. The results are set forth on Table 4.

TABLE 4
Susceptibility of insect species to the
linear ethoxylated alcohol, Tomadol 21-1.

| SPECIES | Tomadol 23-1 test | Test | Percent | |
|---|---|---|---|---|
| (adults unless | dose (uL) of 50% | duration - | mortality | |
| specified) | solution (ETCH) | minutes | (sample size) | |
| Apis mellifera | 3 | 90 | 100 | (25) |
| Artogeia rapae | 1 | 1150 | 0 | (8) |
| Blattella germanica | 2 | 1440 | 91 | (163) |
| Camponotus | 1 | 205 | 100 | (23) |
| pennsylvanicus | | | | |
| Ctenocephalides | 5% soln. in H₂O - | 120 | 100 | (21) |
| felis | spray to wet | | | |
| Diabrotica | 1 | 30 | 100 | (9) |
| undecimpunctata | | | | |
| howardii | | | | |
| Drosophila | 10% soln. in H₂O - | 1440 | 100 | (32) |
| melanogaster | spray to wet | | | |
| Galleria mellonella | 4 | 1440 | 7 | (15) |
| Harmonia axyridis | 1 | 1440 | 95 | (20) |
| Harmonia axyridis | 2 | 1440 | 100 | (20) |
| Lucilia sp. | 1 | 210 | 100 | (10) |
| Melanoplus sp. | 3 | 45 | 100 | (7) |
| Musca domestica | 0.5 | 285 | 100 | (11) |
| Myzus persicae | 5% soln. in H₂O - | 120 | 100 | (10) |
| | spray to wet | | | |
| Oncopeltus fasciatus | 2 | 1397 | 14 | (14) |
| Oryzaephilus | 10% soln. in H₂O - | 140 | 100 | (30) |
| surinamensis | spray to wet | | | |
| Ostrinia nubilalis | 2 | 1440 | 80 | (10) |
| (larvae-5th instar) | | | | |
| Periplaneta americana | 10 | 1440 | 0 | (50) |
| Phaenicia sericata | 2 | 30 | 100 | (1) |
| Polistes fuscatus | 4 | 100 | 75 | (4) |
| Polistes exclamans | 2 | 137 | 100 | (10) |
| Pollenia rudis | 1 | 202 | 100 | (10) |
| Tenebrio molitor | 2 | 1440 | 50 | (18) |
| Thermobia domestica | 1 | 60 | 100 | (50) |
| Vespula maculifrons | 4 | 65 | 100 | (10) |

The data presented demonstrate that specific linear alcohol ethoxylate surfactants alone of the above formula are effective insect control agents against a broad spectrum of insects. Susceptible larger species such as German cockroaches are not immediately knocked down but gradually become moribund over a period of hours with maximum mortality attained at, or before, 24 hours. Cockroach recovery following knockdown was not quantified but some compounds such as Tomadol 91-2.5 produced rapid knockdown (see Table 1) followed by considerable recovery within 24 hours. Smaller species such as C. felis and O. surinamensis were rapidly affected by Tomadol 23-1 but this could have resulted from relatively greater exposure to the compound via spray application. There was no recovery observed for these smaller species. The least susceptible species, O. fasciatus and O. mellonella are taxonomically distinct and of relatively large size.

In view of the above, it will be seen that the several objects of the invention are achieved and other advantageous results attained.

As various changes could be made in the above methods and compositions without departing from the scope of the invention, it is intended that all matter contained in the above description and shown in the accompanying drawings shall be interpreted as illustrative and not in a limiting sense.

What is claimed is:

1. A process for controlling insect populations by applying to an insect habitat a synergistic insecticide composition comprising:
a) an ethoxylated surfactant of the formula:
R—O—(CH₂—CH₂O)ₓ—H
wherein R is a linear alkyl group of from approximately 9 to 15 carbon atoms and X has an average value of from about 1 to 3; and
b) a nicotinoid insecticide.

2. A process as set forth in claim 1 wherein the insect habitat is a cockroach habitat.

3. A process as set forth in claim 1 wherein said surfactant has an HLB of less than approximately 8.7.

4. A process as set forth in claim 1 wherein said surfactant is one in which R is a linear alkyl group of approximately 12 to 13 carbon atoms and X has an average value of about 1.

5. A process as set forth in claim 1 wherein said surfactant is one in which R is a linear alkyl group of approximately 12 to 13 carbon atoms and X has an average of about 2.9.

6. A process as set forth in claim 1 wherein said surfactant is one in which R is a linear alkyl group of approximately 12 to 15 carbon atoms and X has an average value of about 2.8.

7. A process as set froth in claim 1 wherein said surfactant is one in which R is a linear alkyl group of approximately 11 carbon atoms and X has an average value of about 3.

8. A process as set forth in claim 1 wherein said surfactant is one in which R is a linear alkyl group of approximately 14 to 15 carbon atoms and X has an average value of about 2.5.

9. A process as set forth in claim 1 wherein said insecticide is a nicotinoid selected from the group consisting of clothianidin, imidacloprid and thiamethoxam.

10. A process as set forth in claim 1 wherein the ratio of the LC50% value of the composition evaluated after 24 hours at a 10% solution of ethoxylated surfactant to the LC50% value of the nicotinoid insecticide alone evaluated after 24 hours is from about 2.4 to about 6.8.

11. A process as set forth in claim 1 wherein the ratio of the LC50% value of the composition evaluated after 24 hours at a 10% solution of ethoxylated surfactant to the LC50% value of the nicotinoid insecticide alone evaluated after 24 hours is at least about 2.5.

12. A process as set forth in claim 1 wherein the ratio of the LC50% value of the composition evaluated after 24 hours at a 10% solution of ethoxylated surfactant to the LC50% value of the nicotinoid insecticide alone evaluated after 24 hours is from about 2.5 to about 6.7.
